(19) United States
(12) Patent Application Publication
(10) Pub. No.: US 2003/0112830 A1
(43) Pub. Date: Jun. 19, 2003

(54) ISDN communications terminal apparatus

(76) Inventors: Woon-Seob So, Daejon (KR); Dae-Hwan Hwang, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/270,704

(22) Filed: Oct. 14, 2002

(30) Foreign Application Priority Data
Dec. 13, 2001 (KR) 2001-78953

(51) Int. Cl. H04J 3/12

(52) U.S. Cl. 370/524

(57) ABSTRACT

An Integrated Services Digital Network (ISDN) communications terminal apparatus is provided. The ISDN communications terminal apparatus includes a reset and clock signal unit for providing a reset signal and a clock signal needed by a communications service controller; a memory unit for storing a start program and an operating program of the communications terminal apparatus and user data; an input/output unit for receiving needed information from a user and providing needed information to the user; a transformer for matching a signal of ISDN lines or a network termination apparatus; and a communications service control unit which internally has a Reduced Instruction Set Computer (RISC) microprocessor, and is connected to the reset and clock signal unit, the memory unit, the input/output unit, and the transformer to process the communications protocol of each unit. Using a communications service controller having essential functions, the ISDN communications terminal apparatus reduces the number of components to the minimum such that the design of the apparatus is easy, the structure of the apparatus is simple, the price of the apparatus is low, and the size of the apparatus is small.

### BACKGROUND OF THE INVENTION

1. Field of the Invention

The present invention relates to an Integrated Services Digital Network (ISDN) communications terminal apparatus, and more particularly, to an ISDN communications terminal apparatus which is directly connected to an ISDN subscriber matching apparatus on network-side of an ISDN exchange system such that the ISDN communications terminal apparatus can provide an ISDN subscriber with a voice telephone function and an Internet access function.

2. Description of the Related Art

FIG. 2 is a diagram of a functional structure of a prior art ISDN matching communications terminal apparatus. In the prior art, in constructing a subscriber communications terminal apparatus connected to an ISDN exchange, a variety of components having different functions are used, as shown in FIG. 2, such that the structure of the circuit is complicated, the size of the apparatus is big, and unnecessary functions are added to the apparatus. Also, functions for connecting these components to each other should be separately developed using a control circuit. Accordingly, the design and development of the terminal apparatus is difficult, takes much time, and the price of a developed product rises.

### SUMMARY OF THE INVENTION

To solve the above problems, it is a first object of the present invention to provide an ISDN communications terminal which uses a communications service controller having necessary functions such that the structure of the ISDN communications terminal is simple, and high quality voice call and Internet services are provided to subscribers.

It is a second object of the present invention to provide a communications service controller having essential functions of an ISDN communications terminal.

To accomplish the first object of the present invention, there is provided an Integrated Services Digital Network (ISDN) matching communications terminal apparatus comprising: a reset and clock signal unit for providing a reset signal and a clock signal needed by a communications service controller; a memory unit for storing a start program and an operating program of the communications terminal apparatus and user data; an input/output unit for receiving needed information from a user and providing needed information to the user; a transformer for matching a signal of ISDN lines or a network termination apparatus; and a communications service control unit which internally has a Reduced Instruction Set Computer (RISC) microprocessor, and is connected to the reset and clock signal unit, the memory unit, the input/output unit, and the transformer to process the communications protocol of each unit.

To achieve the above object, the present invention also provides an apparatus including: an EIA232 connection unit for transmitting and receiving needed information to/from a terminal connected to the Internet.

To achieve the above object, the present invention also provides an apparatus including the input/output unit comprises: a keypad and Liquid Crystal Display (LCD) unit which is directly connected to the communications service control unit and inputs or outputs information excluding voice information; and an ISDN handset unit which is directly connected to the communications service control unit and inputs or outputs voice information.

To achieve the above object, the present invention also provides an apparatus including the communications service control unit comprises: a RISC core unit for performing central processing function; a reset and clock control unit which receives a reset signal from the outside, initializes each control unit, receives a clock signal from the outside, frequency divides the received clock signal, and provides the frequency divided clock signal to each unit that needs a clock signal; a memory control unit for generating a control signal for reading data from and writing data to a memory; an input/output control unit for processing one or more input/output signals of a keypad, a Liquid Crystal Display (LCD), and a Light-Emitting Device (LED); and an ISDN transceiver unit for transferring data between the ISDN lines or the network termination apparatus and a channel data multiplexer.

To accomplish the second object of the present invention, there is provided a communications service control apparatus for an Integrated Services Digital Network (ISDN) matching communications terminal apparatus comprising: a RISC core unit for performing central processing function; a reset and clock control unit which receives a reset signal from the outside, initializes each control unit, receives a clock signal from the outside, frequency divides the received clock signal, and provides the frequency divided clock signal to each unit that needs a clock signal; a memory control unit for generating a control signal for reading data from and writing data to a memory; a bus arbiter for controlling rights for using a bus among controllers connected to an extended system bus; a timer and interrupt controller for receiving a reference clock signal provided by the reset and clock control unit, generating an appropriate timing signal indicated by a program, and processing internal and external interrupts occurring when the program is executed; a bus bridge unit for transferring a data signal, an address signal, a control signal in accordance with the timing signal of each bus between an extended system bus and an extended peripheral bus; an input/output control unit for processing one or more input/output signals of a keypad, a Liquid Crystal Display (LCD), and a Light-Emitting Device (LED); a D channel control unit for transferring D channel data, including call control protocol data, between the RISC core unit and a channel data multiplexer; a B channel control unit for transferring B1 channel data and B2 channel data between the RISC core unit and a B channel switch; a tone module and voice codec unit for generating tone or melody data, transferring the generated data to a handset through a voice codec, and transferring a voice signal provided by the handset to the B channel switch; the B channel switch for controlling B channel data paths of the B channel control unit, the tone module and voice codec unit, and a time division multiplexer; the channel data multiplexer for transferring data between the ISDN transceiver and the B channel switch and the D channel control unit; and an ISDN transceiver unit for transferring data between the ISDN lines or the network termination apparatus and a channel data multiplexer.

To achieve the above second object, the present invention also provides an apparatus including the memory control unit comprises: a first memory control unit for generating a control signal for accessing one or more of a flash memory, a static memory, and a dynamic memory that are connected to the outside; and a Direct Memory Access (DMA) control unit for generating a needed control signal such that data communications between each controller and the memory are carried out in high speed without intervention of the RISC core unit.

To achieve the above second object, the present invention also provides an apparatus including the B channel control unit comprises: a B1 channel controller for transferring B1 channel data, including user data, between the RISC core unit and the B channel switch; and a B2 channel controller for transferring B2 channel data, including user data, between the RISC core unit and the B channel switch.

To achieve the above second object, the present invention also provides an apparatus including a time division multiplexer control unit for transmitting and receiving data between an external device and the B channel switch using a time division bus.

To achieve the above second object, the present invention also provides an apparatus including a Universal Asynchronous Receiver-Transmitter (UART) control unit for controlling data which is input or output for EIA232 communications, and processing the data to comply with the UART protocol.

### BRIEF DESCRIPTION OF THE DRAWINGS

The above objects and advantages of the present invention will become more apparent by describing in detail preferred embodiments thereof with reference to the attached drawings in which:

FIG. 1 is a diagram of a functional structure of a preferred embodiment of a connection of an ISDN communications terminal apparatus according to the present invention to an ISDN system;

FIG. 2 is a diagram of a functional structure of a prior art ISDN matching communications terminal apparatus;

FIG. 3 is a diagram of a functional structure of a preferred embodiment of an ISDN communications terminal apparatus according to the present invention; and

FIG. 4 is a diagram of a functional structure of a preferred embodiment of a communications service controller of the ISDN communications terminal apparatus of FIG. 3.

### DESCRIPTION OF THE PREFERRED EMBODIMENTS

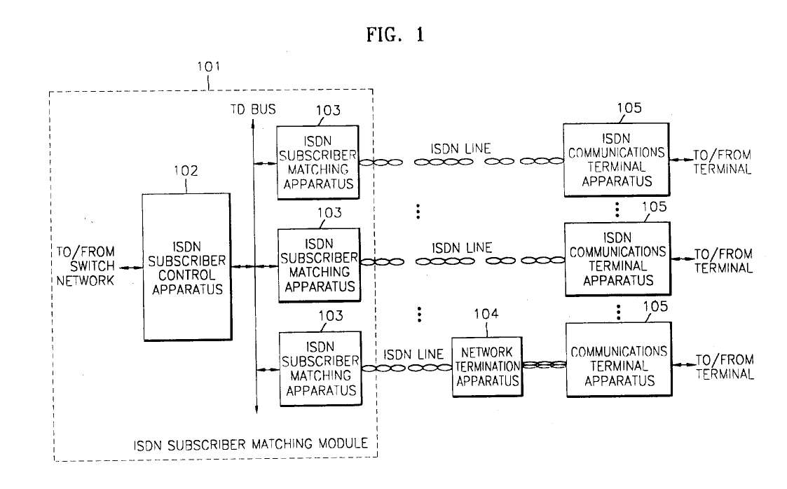

FIG. 1 shows a functional structure of a preferred embodiment of a connection of an ISDN communications terminal apparatus according to the present invention to an ISDN system.

In the ISDN exchange system, an ISDN subscriber matching module 101 includes a subscriber control apparatus 102 which is connected to a switch network, a plurality of ISDN subscriber matching apparatuses 103, each of which is connected to an ISDN line, and a Telephony Device (TD) bus which connect the subscriber control apparatus 102 and the plurality of ISDN subscriber matching apparatuses 103.

The ISDN subscriber control apparatus 102 is connected to the switch network using a message at a 100 Mbps speed. The ISDN subscriber control apparatus 102 communicates 16 bit data, a start signal for transmitting data, a clock signal for transmitting and receiving data, a signal for requesting receiving data, with each ISDN subscribe matching apparatus 103 through the TD bus.

The ISDN subscriber matching apparatuses 103 are connected to the ISDN subscriber control apparatus 102 through the TD bus, and are controlled by the ISDN subscriber control apparatus 102. The ISDN subscriber matching apparatuses 103 are directly connected to a plurality of ISDN communications terminal apparatuses 105 through ISDN lines, each line formed of two physical lines for transmitting and receiving ISDN frame data. Each of the ISDN subscriber matching apparatuses 103 processes a network-side ISDN protocol function and a High-level Data Link Control (HDLC) physical layer function.

A network termination apparatus 104 is placed between the ISDN line and a subscriber terminal apparatus. The network termination apparatus 104 has a U interface with the network-side ISDN line and an S interface with the subscriber-side ISDN communications terminal apparatus 105. The network termination apparatus 104 processes a network termination function of the ISDN line. When the ISDN communications terminal apparatus 105 is directly connected to the U interface, the network termination apparatus 104 is included in the terminal apparatus.

The ISDN communications terminal apparatuses 105 are connected to the ISDN lines or the network termination apparatuses 104, and provide a voice telephone function and an Internet access function to users. Also, the ISDN communications terminal apparatuses 105 may perform a video telephone function and a Terminal Adapter (TA) function by which the ISDN communications terminal apparatus 105 is used as an ordinary telephone.

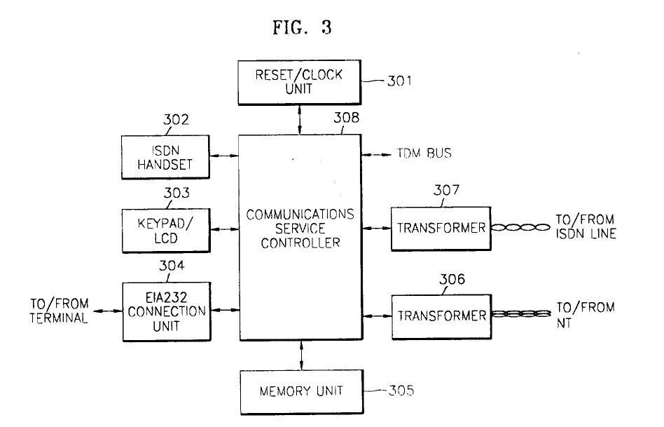

FIG. 3 is a diagram of a functional structure of a preferred embodiment of an ISDN communications terminal apparatus according to the present invention. The ISDN communications terminal apparatus includes a communications service controller 308 for processing communications protocols from the hardware aspect, a reset and clock unit 301 for providing a reset signal and a clock signal, a memory unit 305 for storing a start program and a variety of application programs, an ISDN handset for performing a telephone function, a keypad and an Liquid Crystal Display (LCD) unit 303 for communicating with a user, an EIA232 connection unit for connecting a terminal, transformers 306 and 307 for matching an ISDN line or a network termination apparatus, and performs functions for a communications terminal apparatus.

The reset and clock unit 301 provides a power input reset signal and a switch reset signal to the communications service controller 308 for a necessary period, and a 46.08 MHz clock signal needed in the ISDN communications terminal apparatus. The clock signal is input to the communications service controller 308 and applied to each part after frequency divided and multiple times doubled.

The memory unit 305 includes a Flash Read Only Memory (FROM) which is directly connected to the communications service controller 308, stores a start program or an operating program for the terminal apparatus, and can be connected to an 8 bit bus, a 16 bit bus or a 32 bit bus, and a Dynamic Random Access Memory (DRAM) or a Static Random Access Memory (SRAM) which temporarily stores user data or a variety of application programs, and can be connected to an 8 bit bus, a 16 bit bus, or a 32 bit bus. Also, an external device which can be accessed in the form of a memory map may be connected to the memory unit 305.

The keypad and LCD unit 303 is directly connected to the communications service controller and performs an external input/output function. The keypad has 12 basic key buttons for dialing a telephone number and special numbers and 18 auxiliary key buttons for additional service functions. The auxiliary key buttons include 6 key for shortened dialing, 2 keys for adjusting volume, a key for a speaker function, a key for redialing, a key for hold, and 7 keys for control functions. The LCD is connected to the communications service controller 308 using 8 bits for a data signal, a write control signal, and a signal for distinguishing control commands, and displays information on all states of the ISDN communications terminal apparatus and messages needed by a user. The messages displayed on the LCD include on/off state of a telephone, an originating telephone number and a destination telephone number, information of a current time, etc. By programming the communications service controller 308, a variety of messages may be added or deleted.

The ISDN handset 302 is directly connected to the communications service controller, and inputs or outputs a variety of tone signals and analogue voice signals. The ISDN handset 302 may be formed with a microphone and a speaker or formed with a handset such that voice communications are available.

The EIA232 connection unit 304 has a function for connecting to a terminal for providing an Internet access service function through an EIA232 port. The EIA232 connection unit 304 includes a signal level driver and receiver, and provides a signal for transmitting data, a signal for receiving data, a signal for requesting transmitting data, a receiving-ready signal, and a data carrier detection signal.

The transformers 306 and 307 are directly connected to the communications service controller 308, and performs functions for converting signals for the ISDN lines or the network termination apparatuses 104 and connecting the ISDN lines or the network termination apparatuses 104. For the ISDN lines, the transformer 307 of which the a line-to-device turn ratio is 1:1.8 is used, and for the network termination apparatuses 104, the transformer 306 of which the line-to-device turn ratio is 1:1 is used.

The communications service controller 308 internally has a Reduced Instruction Set Computer (RISC) processor. Connected to the components described above, the communications service controller 308 is a core part which processes protocols according to the communications method of the related components, and performs communications terminal functions from the hardware and software aspects.

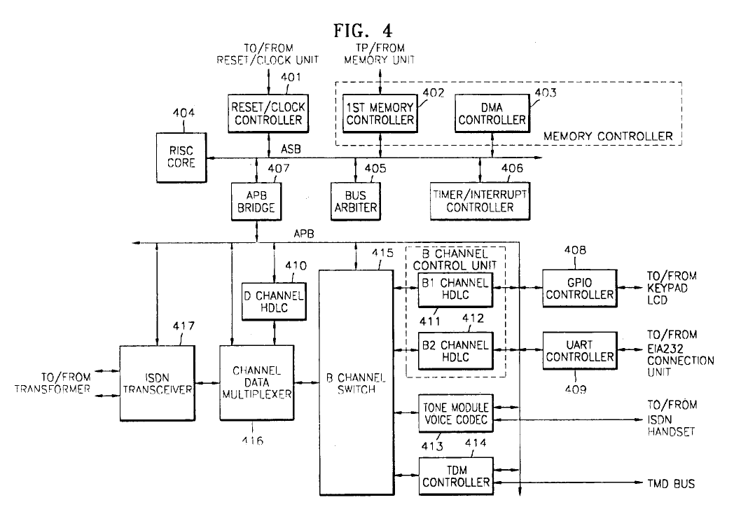

FIG. 4 is a diagram of a functional structure of a preferred embodiment of a communications service controller of the ISDN communications terminal apparatus of FIG. 3. The communications service controller of FIG. 4 includes a reset and clock controller 401 for connecting the ISDN communications terminal apparatus of FIG. 3 to an Advanced System Bus (ASB) so that the ISDN communications terminal apparatus can perform communications functions. The communications service controller also includes a RISC core 404, a memory controller 402, a Direct Memory Access (DMA) controller 403, a bus arbiter 405, a timer/interrupt controller 406, an Advanced Peripheral Bus (APB) bridge 407, a GPIO controller 408, which is connected to the APB bus, a Universal Asynchronous Receiver-Transmitter (UART) controller 409, a D channel controller 410 (D Channel HDLC), a B1 channel controller 411 (B1 Channel HDLC), a B2 channel controller 412 (B2 Channel HDLC), a tone module and voice codec 413, a Time Division Multiplexer (TDM) controller 414, a B channel switch 415, a channel data multiplexer 416, and an ISDN transceiver 417.

The reset and clock controller 401 is connected to the reset and clock unit 301, Initializes all controllers according to a reset signal input from the outside, Generates a reset signal needed by each controller, and load the reset signal on the ASB bus. Meanwhile, a 46.08 MHz clock signal is input from the outside, and the frequency of the clock signal is divided into two and into three in order to generate 23.04 MHz and 15.36 MHZ, respectively. The frequency divided clock signals are multiple times frequency divided again to generate 2.048 MHz, 128 KHz, 8 KHz, and 1 HZ, and then the frequency divided clock signals are provided.

The memory controller 402 generates a control signal for reading data from or writing data into a memory in accordance with a timing signal in order to access the flash memory, the DRAM, and the SRAM that form the memory unit 305 which is connected to the outside.

The DMA controller 403 generates and provides a needed control signal such that data communications between each controller and the memory are carried out in high speed without intervention of a processor.

The RISC core 404 is a 32 bit RISC microprocessor and performs a central processing function of the entire controller.

The bus arbiter 405 is a controller for controlling ASB-bus-using rights of controllers connected to the RISC core 404 through the ASB bus.

The timer/interrupt controller 406 receives a reference clock signal, generates an appropriate timing signal at a time indicated by the program, and processes internal and external interrupts occurring when the program is executed.

The APB bridge 407 is a bridge for connecting the ASB bus and the APB bus with respect to the bus timing signals for communicating a data signal, an address signal, and a control signal.

The GPIO controller 408 processes input and output signals used as a variety of control signals, and mainly processes the input data of the keypad, the output data of the LCD, and an LED driving signal.

The UART controller 409 controls data which is input or output at a maximum 230.4 Kbps speed for EIA232 communications, and processes data to comply with the UART protocol.

The D channel controller 410 transfers D channel data, including call control protocol data, between the processor and the channel data multiplexer 416. For this, the D channel controller 410 is formed with an HDLC transmitter and an HDLC receiver, and generates and extracts an HDLC frame of the D channel data.

The B1 channel controller 411 transfers B1 channel data, including user data, between the processor and the B1 channel switch 415. For this, the B1 channel controller 411 is formed with an HDLC transmitter and an HDLC receiver, and generates and extracts an HDLC frame of the B1 channel data.

The B2 channel controller 412 transfers B2 channel data, including user data, between the processor of the RISC core 404 and the B channel switch 415. For this, the B2 channel controller 412 is formed with an HDLC transmitter and an HDLC receiver, and generates and extracts an HDLC frame of the B2 channel data.

In the tone module and voice codec 413, the tone module generates 16 types of DTMF (DUAL TONE MULTI FREQUENCY) data complying with ITU-T Q.23 standard specifications, single tone data, and melody data, and transfers the generated data to the ISDN handset through the B channel switch 415 and the voice codec complying with the ITU-T G.711 specification.

The TDM controller 414 internally has a time division multiplexer and a demultiplexer, and transfers data between the B channel switch 415 and an external device having a TDM bus interface. This transferring function is used when an ordinary telephone or a video telephone is desired to be used, which is not shown in the drawings.

The B channel switch 410 controls a B channel data path between the B1 channel controller 411, the B2 channel controller 412, the tone module and voice codec 413, and the TDM controller 414, and the channel data multiplexer 416.

The channel data multiplexer 416 divides 2B+D data which is provided by the ISDN transceiver 417 into B channel data and D channel data, and provides the B channel data to the B channel switch 415 and the D channel data to the D channel switch 410. Also, the channel data multiplexer 416 multiplexes B channel data provided by the B channel switch 415 and D channel data provided by the D channel switch 419 so as to transfer data to the ISDN transceiver 417.

The ISDN transceiver 417 processes data, which is provided by the ISDN lines or the network termination apparatus 104, according to the ITU-T I.430 specification, and transfers the data to the channel data multiplexer 416, while the ISDN transceiver 417 processes data, which is provided by the channel data multiplexer 416, according to the ITU-T I.430 specification, and transfers the data to the ISDN lines or the network termination apparatus 104.

So far, optimum embodiments are explained in the drawings and specification, and though specific terminologies are used here, those were only to explain the present invention. Therefore, the present invention is not restricted to the above-described embodiments and many variations are possible within the spirit and scope of the present invention. The scope of the present invention is not determined by the description but by the accompanying claims.

Using the communications service controller having essential functions so as to provide high quality voice call and Internet services having a variety of services, the ISDN communications terminal apparatus according to the present invention reduces the number of components to the minimum such that the design of the apparatus is easy, the structure of the apparatus is simple, the price of the apparatus is low, and the size of the apparatus is small. Also, the simple structure of the ISDN communications terminal apparatus enables easy maintenance and repair, and improves reliability. When necessary, software having a variety of terminal functions can be embedded in the ISDN communications terminal apparatus.

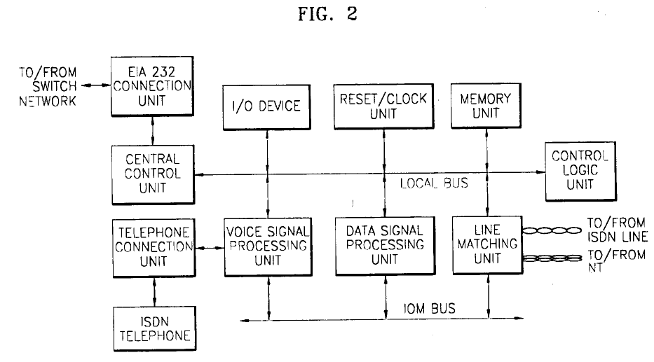

That is, the ISDN communications service terminal according to the present invention forms a ultra-small terminal apparatus, by using an ISDN communications terminal apparatus, in which the functions of FIG. 2, including the central control unit, the voice signal processing unit, the phone connection unit, the data processing unit, the line matching unit, the control logic unit, are integrated, with a communications service controller that is a single device.

Also, the ISDN communications terminal apparatus according to the present invention performs a variety of functions according to user's request, by changing and adding functions. For example, if a video signal processing device is added, the ISDN communications terminal apparatus performs a video telephone function, and if a subscriber line matching device is added, the ISDN communications terminal apparatus performs the Terminal Adapter (TA) function for using an ordinary telephone.

What is claimed is:

1. An Integrated Services Digital Network (ISDN) matching communications terminal apparatus comprising:
a reset and clock signal unit for providing a reset signal and a clock signal needed by a communications service controller;
a memory unit for storing a start program and an operating program of the communications terminal apparatus and user data;
an input/output unit for receiving needed information from a user and providing needed information to the user;
a transformer for matching a signal of ISDN lines or a network termination apparatus; and
a communications service control unit which internally has a Reduced Instruction Set Computer (RISC) microprocessor, and is connected to the reset and clock signal unit, the memory unit, the input/output unit, and the transformer to process the communications protocol of each unit.

2. The apparatus of claim 1, further comprising:
an EIA232 connection unit for transmitting and receiving needed information to/from a terminal connected to the Internet.

3. The apparatus of claim 1, wherein the input/output unit comprises:
a keypad and Liquid Crystal Display (LCD) unit which is directly connected to the communications service control unit and inputs or outputs information excluding voice information; and
an ISDN handset unit which is directly connected to the communications service control unit and inputs or outputs voice information.

4. The apparatus of claim 1, wherein the communications service control unit comprises:
a RISC core unit for performing central processing function;
a reset and clock control unit which receives a reset signal from the outside, initializes each control unit, receives a clock signal from the outside, frequency divides the received clock signal, and provides the frequency divided clock signal to each unit that needs a clock signal;
a memory control unit for generating a control signal for reading data from and writing data to a memory;
an input/output control unit for processing one or more input/output signals of a keypad, a Liquid Crystal Display (LCD), and a Light-Emitting Device (LED); and
an ISDN transceiver unit for transferring data between the ISDN lines or the network termination apparatus and a channel data multiplexer.

5. A communications service control apparatus for an Integrated Services Digital Network (ISDN) matching communications terminal apparatus comprising:
a RISC core unit for performing central processing function;
a reset and clock control unit which receives a reset signal from the outside, initializes each control unit, receives a clock signal from the outside, frequency divides the received clock signal, and provides the frequency divided clock signal to each unit that needs a clock signal;
a memory control unit for generating a control signal for reading data from and writing data to a memory;
a bus arbiter for controlling rights for using a bus among controllers connected to an extended system bus;
a timer and interrupt controller for receiving a reference clock signal provided by the reset and clock control unit, generating an appropriate timing signal indicated by a program, and processing internal and external interrupts occurring when the program is executed;
a bus bridge unit for transferring a data signal, an address signal, a control signal in accordance with the timing signal of each bus between an extended system bus and an extended peripheral bus;
an input/output control unit for processing one or more input/output signals of a keypad, a Liquid Crystal Display (LCD), and a Light-Emitting Device (LED);
a D channel control unit for transferring D channel data, including call control protocol data, between the RISC core unit and a channel data multiplexer;
a B channel control unit for transferring B1 channel data and B2 channel data between the RISC core unit and a B channel switch;
a tone module and voice codec unit for generating tone or melody data, transferring the generated data to a handset through a voice codec, and transferring a voice signal provided by the handset to the B channel switch;
said B channel switch for controlling B channel data paths of the B channel control unit, the tone module and voice codec unit, and a time division multiplexer;
said channel data multiplexer for transferring data between the ISDN transceiver and the B channel switch and the D channel control unit; and
an ISDN transceiver unit for transferring data between the ISDN lines or the network termination apparatus and a channel data multiplexer.

6. The apparatus of claim 5, wherein the memory control unit comprises:
a first memory control unit for generating a control signal for accessing one or more of a flash memory, a static memory, and a dynamic memory that are connected to the outside; and
a Direct Memory Access (DMA) control unit for generating a needed control signal such that data communications between each controller and the memory are carried out in high speed without intervention of the RISC core unit.

7. The apparatus of claim 5, wherein the B channel control unit comprises:
a B1 channel controller for transferring B1 channel data, including user data, between the RISC core unit and the B channel switch; and
a B2 channel controller for transferring B2 channel data, including user data, between the RISC core unit and the B channel switch.

8. The apparatus of claim 5, further comprising:
a time division multiplexer control unit for transmitting and receiving data between an external device and the B channel switch using a time division bus.

9. The apparatus of claim 5, further comprising:
a Universal Asynchronous Receiver-Transmitter (UART) control unit for controlling data which is input or output for EIA232 communications, and processing the data to comply with the UART protocol.
